(19) United States
(12) Patent Application Publication
(10) Pub. No.: US 2012/0104266 A1
(43) Pub. Date: May 3, 2012

(54) RADIATION DETECTING ELEMENT, METHOD OF PRODUCING SAME, RADIATION DETECTING MODULE, AND RADIATION IMAGE DIAGNOSTIC APPARATUS

(75) Inventors: Nobuyuki Yokosawa, Saitama (JP); Mitsuhiro Kawanishi, Tokyo (JP); Takahiro Igarashi, Kanagawa (JP); Ikumi Kusayama, Kanagawa (JP)

(73) Assignee: Sony Corporation, Tokyo (JP)

(21) Appl. No.: 13/280,631

(22) Filed: Oct. 25, 2011

(30) Foreign Application Priority Data
Nov. 2, 2010 (JP) 2010-246506

(51) Int. Cl. G01T 1/20; C01D 17/00; B05D 1/00; B32B 3/30; B32B 3/02

(52) U.S. Cl. 250/369; 428/172; 428/157; 427/157; 423/499.1

(57) ABSTRACT

A method of producing a radiation detecting element with an improved resolution property, a radiation detecting element, a radiation detecting module, and a radiation image diagnostic apparatus are provided. The radiation detecting element includes a scintillator layer on a substrate. The scintillator layer includes a plurality of columnar crystals having substantially no irregularity on each side.

### BACKGROUND

The present disclosure relates to a radiation detecting element, a method of producing the radiation detecting element, a radiation detecting module, and a radiation image diagnostic apparatus, in which radiation is converted into visible light and thereby counting and analysis of the radiation is performed.

In recent years, due to advances in Thin-Film Transistor (TFT) technology for liquid crystal displays, a variety of large-area digitized Flat Panel Detectors (FPDs) have been developed and used in medical image analyses or industrial non-destructive inspections.

The FPD is a detector that reads a radiation image (X-rays, α-rays, β-rays, electron beams, ultraviolet rays, or the like) and display the image on a display instantly. This displayed image may be extracted directly as digital information and thus, handling such as saving, processing, transfer, and the like of data is easy. In addition, although the characteristics such as sensitivity depend on the shooting condition, it has been confirmed that the characteristics are equal to or better than those of an ordinary screen-film-system photographing technique and an ordinary computed radiography photographing technique.

For the FPDs, there are two methods, namely, a direct method of reading radiation as a charge signal, and an indirect method of reading radiation by converting the radiation into visible light by a phosphor layer (a scintillator layer) provided on a optical detection substrate. The scintillator layer is formed by codeposition using cesium iodide (CsI) in which a crystal grows to be column-shaped as a main agent, and an inorganic material such as thallium (Tl), sodium (Na), or the like as an activator to increase the sensitivity.

In an FPD of the indirect method (for example, a radiation detecting element), radiation emitted from a top surface is converted into light in a scintillator layer, and the light is read from an undersurface side of the scintillator layer by a photodetector. To improve the resolution property of the FPD, it is desirable that a Modulation Transfer Function (MTF) be uniform, i.e., a plurality of columnar crystals of the scintillator layer grow and spread uniformly. Therefore, for example, Japanese Unexamined Patent Application Publication No. 2008-88531 proposes a method of obtaining a high-precision and stable scintillator layer, by precisely controlling any of the temperature of a vaporized deposition material (a main agent and an activator), the temperature of a container containing the deposition material, and the deposition rate. Further, Japanese Unexamined Patent Application Publication No. 2008-96344 proposes a method of controlling nonuniformity of the MTF characteristics, by providing a reflection limiting means between a scintillator layer and a reflection layer provided on the scintillator layer, and allowing reflection light to have an in-plane part.

### SUMMARY

However, in the radiation detecting element of Japanese Unexamined Patent Application Publication No. 2008-88531, reduction in variations in growth and spread of the columnar crystals of the scintillator layer is not sufficient, and a difference in film thickness between a central part and a peripheral part of the scintillator layer, namely, a difference in growth rate between the columnar crystals still exist. Further, in Japanese Unexamined Patent Application Publication No. 2008-96344, a light-absorbing layer, an antireflection film, or the like is provided as the reflection limiting means and thus, the number of production processes increases. Moreover, no improvement in the film quality of the scintillator layer itself has been achieved.

Meanwhile, in the field of organic electroluminescence display and the like using organic materials, various methods have been developed to obtain an approximately uniform film thickness by vapor deposition. For example, Japanese Unexamined Patent Application Publication No. 2006-225725 proposes a deposition apparatus in which the directivity of a deposition material released to a deposited member such as a substrate is weakened and thereby, the film thickness of a film formed on the deposited member is made approximately uniform. Specifically, a container for the release of the deposition material at the same level as the deposited member is provided, and a plurality of releasing holes to release the deposition material is formed on the deposited member side of this container. Releasing the deposition material vaporized from these releasing holes to the deposited member makes it possible to form an approximately uniform deposited film.

However, a heating temperature when an organic material is used as a deposition material is around 300° C., whereas application of heat at a temperature of 700° C. to 1,000° C. or higher is desired when an inorganic material such as CsI is used. Therefore, it is difficult to directly use the deposition apparatus proposed in Japanese Unexamined Patent Application Publication No. 2006-225725. In addition, there is no reported case in which a deposition method described in Japanese Unexamined Patent Application Publication No. 2006-225725 or a similar method is applied to an inorganic material to form a deposited film.

In view of the foregoing, it is desirable to provide a method of producing a radiation detecting element that improves a resolution property, a radiation detecting element, a radiation detecting module, and a radiation image diagnostic apparatus produced based on this method.

According to an embodiment of the present disclosure, there is provided a method of producing a radiation detecting element, the method including heating and vaporizing a deposition material, guiding the vaporized deposition material to a deposition container having releasing holes, and forming a scintillator layer including a plurality of columnar crystals having substantially no irregularity on each side, by releasing the vaporized deposition material from the releasing holes, and evaporating the released deposition material onto the substrate.

A radiation detecting element according to an embodiment of the present disclosure is formed by the method described above, and each side of the columnar crystals in the scintillator layer has substantially no irregularity and is flat.

A radiation detecting module according to an embodiment of the present disclosure includes the above-described radiation detecting element, and a photoelectric transducer transducing light, which is converted by the radiation detecting element, into an electric signal.

A radiation image diagnostic apparatus according to an embodiment of the present disclosure includes a radiation source device producing radiation, and a radiation detector having the above-described radiation detecting element.

In the radiation detecting element, the method of producing the radiation detecting element, the radiation detecting module, and the radiation image diagnostic apparatus according to the embodiments of the present disclosure, the deposition material vaporized by the application of heat is guided to the deposition container having a plurality of releasing holes, and the deposition material is released from the releasing holes and then evaporated onto the substrate. As a result, variations in growth and column diameter among the columnar crystals of the scintillator layer are decreased, and unevenness in film quality of the scintillator layer is reduced.

According to the radiation detecting element, the method of producing the radiation detecting element, the radiation detecting module, and the radiation image diagnostic apparatus in the embodiments of the present disclosure, the deposition material is released from the releasing holes and evaporated onto the substrate and thus, it is possible to form the scintillator layer with the flat columnar crystals having substantially no irregularity on each side, which may reduce unevenness in the film thickness. This reduces variations of MTF characteristics in a central part and a peripheral part of the substrate, thereby improving a resolution property.

It is to be understood that both the foregoing general description and the following detailed description are exemplary, and are intended to provide further explanation of the technology as claimed.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the technology.

FIG. 1 is a cross-sectional diagram illustrating a configuration of a radiation detecting element according to a first embodiment of the present disclosure.

FIGS. 2A and 2B are schematic diagrams illustrating a deposition apparatus to form a scintillator layer in FIG. 1.

FIG. 3 is a schematic diagram illustrating a deposition apparatus of an existing example.

FIGS. 4A to 4C are schematic diagrams of columnar crystals of a scintillator layer and a cross-sectional diagram of the scintillator layer, according to the existing example.

FIGS. 5A to 5C are schematic diagrams of columnar crystals of the scintillator layer in FIG. 1.

FIG. 6 is a characteristic diagram illustrating a change in MTF by a substrate position of each of the scintillator layer in FIG. 1 and the scintillator layer in the existing example.

FIG. 7 is a cross-sectional diagram illustrating a configuration of a radiation detecting element according to a second embodiment of the present disclosure.

FIG. 8 is a block diagram illustrating a configuration of an application example of the radiation detecting elements of the embodiments.

### DETAILED DESCRIPTION OF EMBODIMENTS

Embodiments of the present disclosure will be described below in detail with reference to the drawings in the following order.

### First Embodiment

### Radiation Detecting Element with Scintillator Layer Directly Provided on Sensor Substrate

(1) Configuration of Radiation Detecting Element

(2) Production Method

### Second Embodiment

### Radiation Detecting Element with Scintillator Layer Provided on Support Substrate Side

### First Embodiment

### Configuration of Radiation Detecting Element

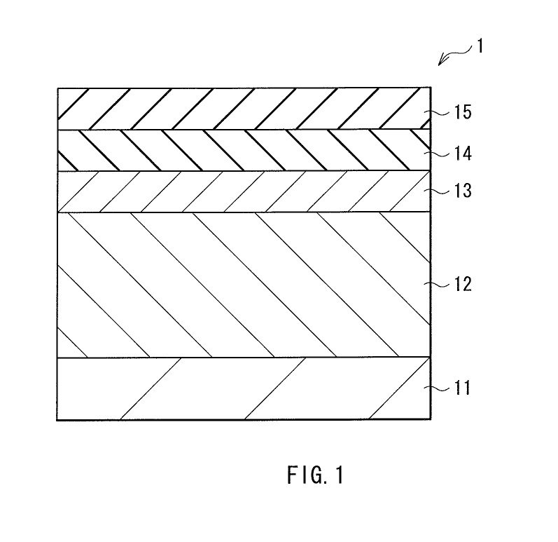

FIG. 1 illustrates a cross-sectional configuration of a radiation detecting module having a radiation detecting element 1 according to the first embodiment of the present disclosure. The radiation detecting element 1 has a sensor substrate 11, a scintillator layer 12, an adhesive layer 13, a reflection layer 14, and a protective layer 15 in this order. The radiation detecting module includes the radiation detecting element 1, and a switching element as well as a photoelectric transducer provided on the sensor substrate.

The sensor substrate 11 includes the switching element (not illustrated) such as TFT, and a photoelectric conversion section (not illustrated) configured by using a plurality of photoelectric transducers to convert light into an electric signal. This sensor substrate 11 is made of a material used in a radiation detector, e.g. glass. It is preferable for the thickness of the sensor substrate 11 to be 50 μm to 700 μm both inclusive in terms of durability and weight reduction.

The scintillator layer 12 is a layer that contains a radiation phosphor that emits fluorescence by application of radiation. As a phosphor material, it is desirable to use a material absorbing energy of radiation, having relatively high efficiency of conversion into an electromagnetic wave having a wavelength of 300 nm to 800 nm both inclusive, namely, an electromagnetic wave (light) ranging from UV light to infrared light with visible rays in the middle, and easily forming a columnar crystal structure by deposition. This is because the formation of the columnar crystal structure makes it possible to suppress scattering of emitted light within the crystal by a light guide effect, and increase the film thickness of the scintillator layer 12, and thereby a high image resolving power is achieved. As a specific phosphor material, it is desirable to use, for example, CsI as a main agent, and, for example, Tl or Na as an activator to supplement luminous efficiency and the like. Further, it is desirable that the thickness of the scintillator layer 12 be, for example, 100 μm to 700 μm both inclusive, and it is desirable that the thickness of the columnar crystal be 1 μm to 10 μm both inclusive at the front surface.

It is to be noted that the phosphor material used for the scintillator layer 12 is not limited to the above-mentioned CsI, Tl, and the like. For example, an alkali metal halide system phosphor expressed by a basic compositional formula (I): M^{I}X.aM^{II}X′₂.bM^{III}X″₃ may be used. In the formula, M^{I} represents at least one kind of alkali metal selected from the group consisting of lithium (Li), Na, potassium (K), rubidium (Rb), and Cs. M^{II} represents at least one kind of alkaline earth metal or divalent metal selected from the group consisting of beryllium (Be), magnesium (Mg), calcium (Ca), strontium (Sr), barium (Ba), nickel (Ni), copper (Cu), zinc (Zn), and cadmium (Cd). M^{III} represents at least one kind of rare earth element or trivalent metal selected from the group consisting of scandium (Sc), yttrium (Y), lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), aluminum (Al), gallium (Ga), and indium (In). Further, each of X, X′, and X″ represents at least one kind of halogen selected from the group consisting of fluorine (F), chlorine (Cl), bromine (Br), and iodine (I). A represents at least one kind of rare earth element or metal selected from the group consisting of Y, Ce, Pr, Nd, Sm, Eu, Gd, Tb, Dy, Ho, Er, Tm, Yb, Lu, Na, Mg, Cu, silver (Ag), Tl, and bismuth (Bi). Furthermore, a, b, and z respectively represent numerical values within 0≦a<0.5, 0≦b<0.5, and 0<z<1.0. In addition, it is desirable that M^{I} of the basic compositional formula (I) described above at least include Cs, and it is desirable that X at least include I. Moreover, in particular, A is preferably Tl or Na. It is desirable that z be 1×10⁻⁴≦z≦0.1.

In addition, a rare earth activated alkaline earth metal fluoride halide system phosphor expressed by a basic compositional formula (II): M^{II}FX:zLn, other than the basic compositional formula (I) may be used. In the formula, M^{II} represents at least one kind of alkaline earth metal selected from the group consisting of Ba, Sr, and Ca. Ln represents at least one kind of rare earth element selected from the group consisting of Ce, Pr, Sm, Eu, Tb, Dy, Ho, Nd, Er, Tm, and Yb. X represents at least one kind of halogen selected from the group consisting of Cl, Br, and I. Further, z is 0<z≦0.2. It is to be noted that as M^{II} in the above-described formula, occupation of not less than half of Ba is desired. Ln is preferably Eu or Ce in particular. Moreover, there are LnTaO₄: (Nb, Gd) system, Ln₂SiO₅: Ce system, LnOX: Tm system (Ln is a rare earth element), Gd₂O₂S:Tb, Gd₂O₂S:Pr, Ce, ZnWO₄, LuAlO₃:Ce, Gd₃Ga₂₅O₁₂: Cr, Ce, HfO₂, and the like.

The adhesive layer 13 is intended to connect the scintillator layer 12 with the reflection layer 14. As a material of the adhesive layer 13, for example, an adhesive such as epoxy resin, a pressure sensitive adhesive, or the like may be used.

The reflection layer 14 is intended to reflect fluorescence emitted from the scintillator layer 12 to the side opposite to the sensor substrate 11, thereby increasing the quantity of the fluorescence light reaching the photoelectric transducer provided at the sensor substrate 11. In addition, the reflection layer 14 also serves as a moisture-proof protective layer of the scintillator layer 12. It is preferable to use a metallic thin film as a material of the reflection layer 14, and, for example, Al, Ag, Ni, and Ti may be used. Besides this, a thermosetting resin material such as silicon resin, epoxy resin, and the like, or a thermoplastic resin material such as methacryl resin including acrylic resin etc., a polyvinyl acetal resin including butyral resin etc., or the like may be used as a binder material, and light scattering particles of titanium oxide (TiO₂), aluminum oxide (Al₂O₃), silicon dioxide (SiO₂), or the like whose mean particle size is approximately submicron may be contained. It is preferable that the film thickness of the reflection layer 14 be, for example, 50 nm to 200 nm both inclusive.

The protective layer 15 is intended to protect the reflection layer 14, and is provided on the reflection layer 14. As a material of the protective layer 15, there are, for example, polyurethane, vinyl chloride copolymer, vinyl chloride-vinyl acetate copolymer, vinyl chloride-vinylidene chloride copolymer, vinyl chloride-acrylonitrile copolymer, butadiene-acrylonitrile copolymer, polyamide resin, polyvinylbutyral, polyester, cellulose derivative, polyimide, polyamide, polyparaxylene, and styren-butadiene copolymer. Moreover, synthetic rubber resin, phenolic resin, epoxy resin, urea resin, melamine resin, phenoxy resin, silicon resin, acrylic resin, urea formamide resin, and the like may be included. The thickness of the protective layer 15 is preferably 10 μm to 60 μm both inclusive, and more preferably, 20 μm to 50 μm both inclusive.

### Deposition Apparatus

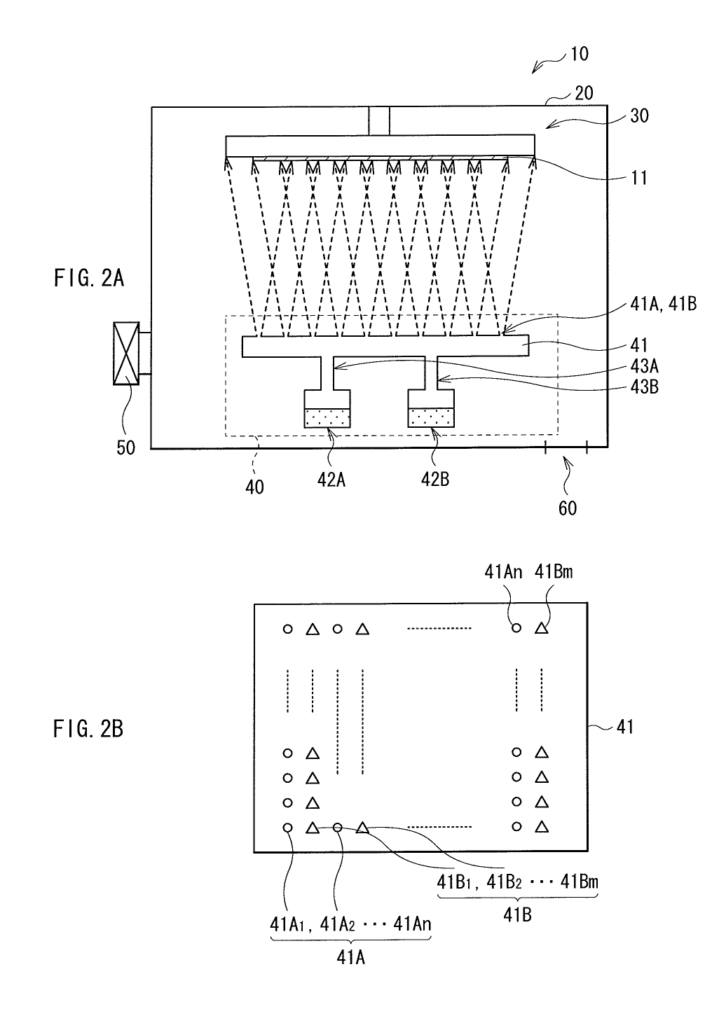

The scintillator layer 12 in the present embodiment is formed using a deposition apparatus 10 illustrated in FIGS. 2A and 2B. As illustrated in FIG. 2A, the deposition apparatus 10 includes a holder 30 to hold the sensor substrate 11 (deposited member) in a vacuum chamber (deposition chamber) 20, a heating vaporization section 40, a vacuum pump (evacuation means) 50, and a gas inlet nozzle 60. It is to be noted that the deposition apparatus 10 may additionally have various members provided in a known vacuum deposition apparatus. For example, the deposition apparatus 10 may have a matching box washing the deposited member, a vacuum gage measuring the degree of vacuum in the vacuum chamber 20, and the like.

In the heating vaporization section 40, deposition materials (phosphors: e.g. CsI and TlI) are vaporized by heating, and thereby a scintillator layer is formed at the sensor substrate 11 held by the holder 30. The heating vaporization section 40 is provided with a deposition container (plate) 41 and vaporization containers 42A and 42B. The vaporization containers 42A and 42B are provided to heat and vaporize CsI that is the main agent and TlI that is the activator, which are the deposition materials, independently of each other. In the plate 41, releasing holes 41A and 41B to release the vaporized deposition materials (CsI and TlI) are provided. Between the plate 41 and the vaporization containers 42A and 42B, induction tubes 43A and 43B are provided, and the vaporized CsI and TlI are guided to the plate 41 by these induction tubes 43A and 43B. In addition, between the sensor substrate 11 and the plate 41, there is provided a shutter (not illustrated) to block or open a trajectory of CsI and TlI released from the releasing holes 41A and 41B to the sensor substrate 11. It is to be noted that the space between the sensor substrate 11 disposed at the holder 30 and the plate 41 is preferably, for example, 100 mm to 500 mm both inclusive. Moreover, other than the members mentioned above, although not illustrated, a heat retention cover that covers the plate 41, a heater to heat the induction tubes 43A and 43B, a cooling plate to prevent application of heat at or higher than the decomposition temperature of the deposition material, and the like may be provided.

FIG. 2B illustrates a plane configuration of the plate 41. The size of the plate 41 is smaller than that of the sensor substrate 11 serving as the deposited member, and on the top surface thereof, the releasing holes 41A and 41B to respectively release CsI and TlI are provided at predetermined intervals, for example, vertically and horizontally in columns and rows. The spacing between the releasing holes 41A and the spacing between the releasing holes 41B are arbitrary, but it is desirable that the spacing of the releasing holes 41A1 to 41An and the spacing of the releasing holes 41B1 to 41Bn be constant. In addition, although not illustrated, channels to lead CsI to the releasing holes 41A1 to 41An and TlI to the releasing holes 41B1 to 41Bn independently are provided inside the plate 41. As for the quality of materials of the plate 41 and the induction tubes 43A and 43B, it is desirable to use a metallic material which is resistant to the vaporization temperature (for example, around 700° C. to 1,000° C.) of an inorganic material such as CsI used as the deposition material, and does not react to the deposition materials. Specifically, for example, Inconel (trademark) or the like may be used.

It is to be noted that the shape of the plate 41 is not limited to a rectangle illustrated in FIG. 2B, and may be a circle or a polygon, and it is desirable to use a shape suitable for the shape of the sensor substrate 11. Further, the respective shapes of the releasing holes 41A and 41B are not limited to a circle and a triangle illustrated in FIG. 2B, and may be a rectangle or a polygon. Furthermore, here, the channels where CsI and TlI flow are provided inside the plate 41, but two plates may be disposed vertically, and space may be formed inside these plates to lead CsI and TlI independently. Providing the space in the inside of the plates makes it possible to render the density of the deposition materials uniform.

### Production Method

First, the sensor substrate 11 is disposed at the holder 30 in the vacuum chamber 20 so that a deposited surface faces downward. Subsequently, the vaporization containers 42A and 42B are filled with CsI and TlI and then, the shutter is closed and further, the vacuum chamber 20 is closed.

Next, air is exhausted by driving the vacuum pump 50 until the vacuum chamber 20 becomes, for example, 1×10⁻⁴ Pa. Subsequently, for example, argon (Ar) gas is introduced by the gas inlet nozzle 60 while the exhaust is continued, and the pressure in the vacuum chamber 20 is adjusted to be, for example, 0.1 Pa to 10 Pa.

Subsequently, power is applied to the vaporization containers 42A and 42B by driving a power source (not illustrated) and thereby, CsI and TlI are heated at, for example, 600° C. to 900° C. both inclusive. After starting the heating, the temperatures of CsI and TlI are measured by a thermocouple (not illustrated) disposed in the bottom of the vaporization containers 42A and 42B. Subsequently, upon confirming that each temperature has reached the vaporization temperature, the shutter is opened, and deposition is started.

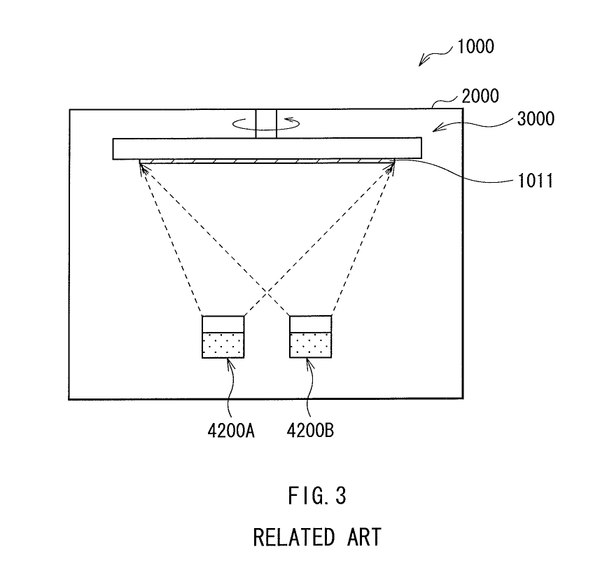

Subsequently, the shutter is closed after the deposition is performed for a predetermined time according to the set film thickness of the scintillator layer 12, and application of the power to the vaporization containers 42A and 42B is stopped and thereby the deposition is completed. Finally, the vacuum chamber 20 is opened to the atmosphere after the sensor substrate 11 is sufficiently cooled and then, the sensor substrate 11 in which the scintillator layer 12 is formed is taken out. It is to be noted that here, the holder 30 is fixed, but the deposition may be performed while rotating the sensor substrate 11 at the time of deposition, like a holder 3000 (FIG. 3) of an ordinary deposition apparatus which will be described later.

After the scintillator layer 12 is formed, the adhesive layer 13, the reflection layer 14, and the protective layer 15 are formed by, for example, coating, deposition, or transfer. Specifically, for example, after an epoxy resin or an acrylic resin as the adhesive layer 13 is applied thinly onto the scintillator layer 12, Al is evaporated to form the reflection layer 14. Subsequently, a silicon resin as the protective layer 15 is formed on the reflection layer 14 by, for example, coating. Then, after moisture-proof processing is performed, the production proceeds to assembly processes for the radiation detector and the like.

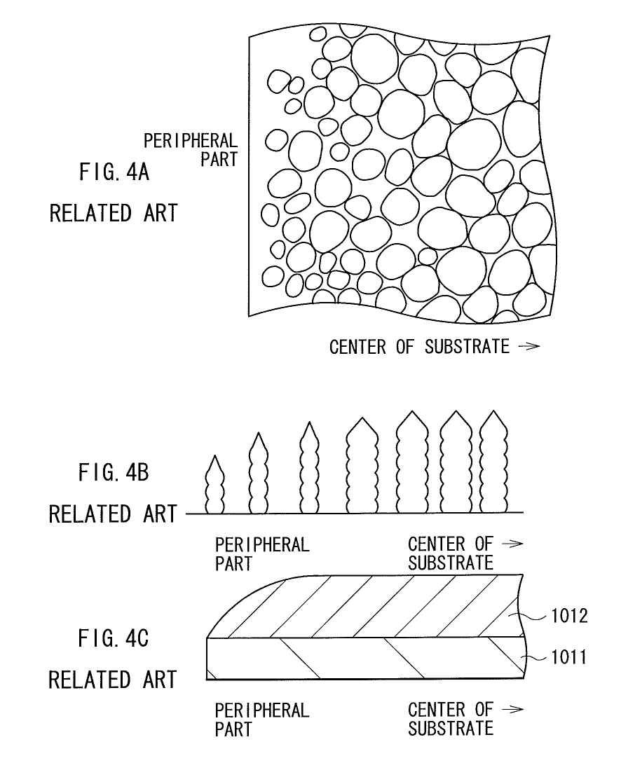

FIG. 3 is a schematic diagram of a deposition apparatus 1000 used to form an ordinary scintillator layer 1012 (FIGS. 4A to 4C). In this deposition apparatus 1000, a sensor substrate 1011 is disposed at the holder 3000 in a state of a deposited surface (a light-receiving surface) facing downward, and evacuation in a vacuum chamber 2000 is performed and subsequently, deposition is carried out by rotation about the center of the sensor substrate 1011 serving as an axis. Deposition materials (CsI and TlI) are respectively contained in vaporization containers 4200A and 4200B disposed at arbitrary positions facing the sensor substrate 1011, and the deposition materials are preheated up to a predetermined temperature. During the preheating, a shutter (not illustrated) is closed so that the deposition materials do not reach the sensor substrate 1011. The shutter is opened when the deposition materials reach a vaporization temperature, and deposition is started.

In the scintillator layer 1012 formed using the deposition apparatus 1000 described above, the vaporization source of each of the deposition materials (CsI and TlI) is at one location, i.e. a spot and therefore, the directions in which the deposition materials are input on the sensor substrate 1011 greatly vary. FIGS. 4A and 4B schematically illustrate a plane configuration and cross-sectional configurations of columnar crystals of the scintillator layer 1012. In this scintillator layer 1012, many columnar crystals with large column diameters are densely formed in proximity to a position facing the vaporization source, namely, in the vicinity of the center of the scintillator layer 1012. In contrast, at a position apart from the vaporization source, namely, on a peripheral part, columnar crystals that are sparse and have small column diameters occupy the majority. This is because the quantity of the deposition materials released toward the peripheral part is small. Further, because the quantity of the deposition materials released toward the peripheral part is small, the columnar crystals in the peripheral part do not easily grow. Therefore, as illustrated in FIG. 4C, the film thickness of the entire scintillator layer 1012 is relatively uniform in proximity to the center, but decreases in the peripheral part as if sloping in a direction to an end surface. In addition, as described above, the directions in which the deposition materials are input greatly vary between a central part and a peripheral part of the substrate. Therefore, the tips of the columnar crystals also become sharper in the peripheral part of the substrate than in the central part of the substrate, and a spatial frequency increases, which causes a decline in contrast. As a measure against this, there is a method of using by removing a peripheral part where the film thickness of the scintillator layer 1012 is thin, but in this method, an additional process for the removal is desired, bringing such a disadvantage that the producibility of the scintillator layer with respect to the deposition materials declines. In addition, because the column diameters vary among the columnar crystals, variations in MFT characteristic in the plane of the scintillator layer exist. Furthermore, in the ordinary deposition apparatus 1000, the deposition materials are evaporated while the sensor substrate 1011 is rotated by the holder 3000 and thus, when the position of the vaporization source offsets a rotation shaft, the vaporization directions of the deposition materials are nonuniform, and a vapor deposition rate fluctuates. As a result, irregularities are formed on sides, like the columnar crystals illustrated in FIG. 4B. Specifically, the difference between projections and depressions is about 2 μm or more. Due to these irregularities, a light guide effect is lost, and light passing through the columnar crystals is scattered, which lowers the MTF characteristics.

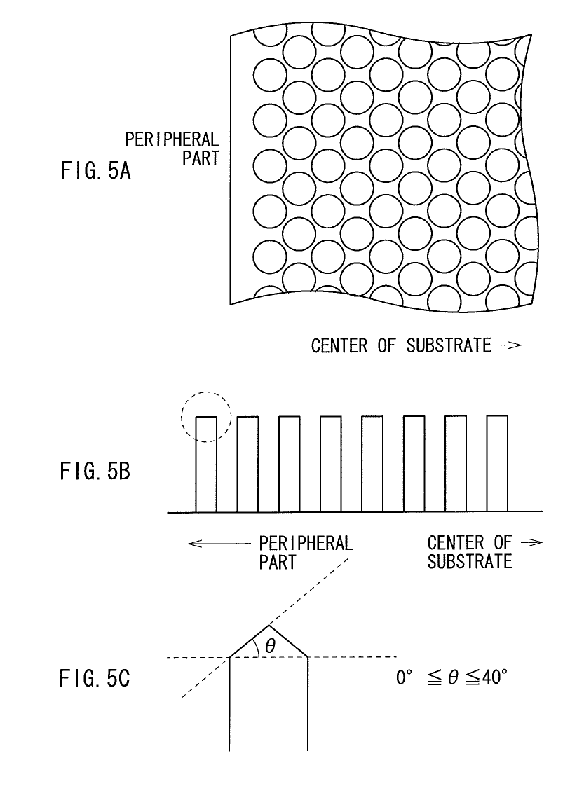

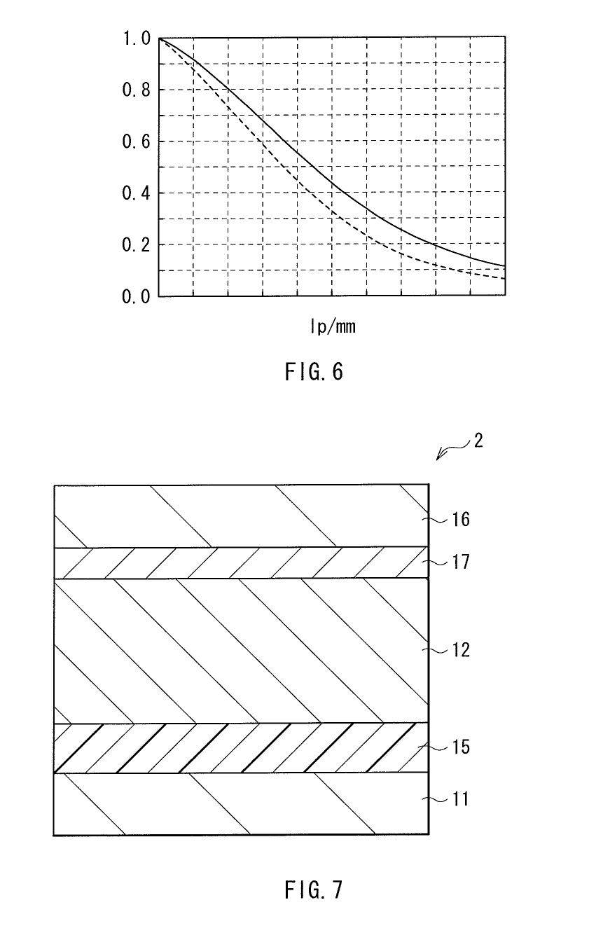

In contrast, in the present embodiment, the plate 41 with the releasing holes 41A1 to 41An and 41B1 to 41Bm are provided above the vaporization containers 42A and 42B. The vaporized CsI and TlI are guided to this plate 41, and respectively released from the releasing holes 41A1 to 41An and 41B1 to 41Bm, and thereby the scintillator layer 12 is formed. In other words, the scintillator layer 12 is formed with more than one vaporization source. This decreases a difference in incident direction of the deposition material and a difference in deposition material reaching the sensor substrate 11, between a central part and a peripheral part of the substrate. Therefore, as illustrated in FIGS. 5A and 5B, the columnar crystals of the scintillator layer 12 grow uniformly in both the central part and the peripheral part of the substrate, and the columnar crystals are formed to have approximately uniform column diameters and intervals. In other words, there is obtained the scintillator layer 12 in which differences in quality and film thickness between the central part and the peripheral part of the substrate are small, the entire surface is flat, and the film quality is uniform. Specifically, a difference in growth rate between the columnar crystals, namely, a different in in-plane film thickness of the scintillator layer 12 is 10% or less. In addition, as described above, in the present embodiment, the deposition materials are flatly released on the plane from the releasing holes 41A1 to 41An and 41B1 to 41Bm and thus, as compared to the deposition materials released by the ordinary deposition apparatus 1000, it is less likely that the vaporization directions to the sensor substrate 11 will vary. For this reason, the side of one columnar crystal has substantially no irregularity, and is flat. Specifically, in a glowing direction of the columnar crystal, a difference between a projection and a depression in an arbitrary portion is suppressed to 1 μm or less. Further, as illustrated in FIG. 5C, an angle θ formed by an inclined surface of the tip of each columnar crystal falls within a range of 0 degrees to 40 degrees both inclusive. FIG. 6 illustrates a change in MTF by the substrate position of each of the radiation detecting element 1 in the present embodiment (a solid line) and an existing example (a broken line). It is found that in the radiation detecting element 1 of the present embodiment, a decline in the MTF characteristics in the peripheral part of the substrate is improved.

In this way, in the radiation detecting element 1 of the present embodiment, the plate 41 with the releasing holes 41A1 to 41An and 41B1 to 41Bm is provided above the vaporization containers 42A and 42B, and CsI and TlI are released from these releasing holes 41A1 to 41An and 41B1 to 41Bm, respectively, and therefore, variations in density, column diameter, growth rate, and tip angle among the columnar crystals are reduced. In other words, there is formed the scintillator layer 12 in which unevenness in film thickness and film quality is reduced and the entire surface is flat. Therefore, the distribution of the MTF characteristics of the scintillator layer 12 is reduced, and the noise performance and input characteristic are improved, enhancing the resolution property of the scintillator.

### Second Embodiment

The second embodiment will be described below with reference to FIG. 7. It is to be noted that the same elements as those of the first embodiment are provided with the same reference characters as those of the first embodiment, and the description will be omitted. A radiation detecting element 2 in the present embodiment is a so-called scintillator panel with a base layer 17, the scintillator layer 12, and the protective layer 15 on a support substrate 16. FIG. 7 illustrates a cross-sectional configuration of a radiation detecting module in which this radiation detecting element 2 is provided on the sensor substrate 11 having a switching element (not illustrated) such as TFT and a plurality of photoelectric transducers (not illustrated), with the protective layer 15 side facing downward. That the scintillator layer 12 in the present embodiment is formed by deposition on the support substrate 16 side where the base layer 17 is formed. In addition, the protective layer 15 is intended to protect the scintillator layer 12, and provided on the scintillator layer 12.

The support substrate 16 is made of a material allowing radiation to pass therethrough, e.g. glass, graphite, light metals such as beryllium (Be), titanium (Ti), aluminum (Al), or alloys thereof, ceramics, polyethylene terephthalate (PET), polyethylene naphthalate (PEN), polyimide, or the like. The thickness of the support substrate 16 is preferably 50 μm to 500 μm both inclusive in terms of durability and weight reduction, like the thickness of the sensor substrate 11.

The base layer 17 is intended to protect the support substrate 16 from corrosion and the like. As a material of the base layer 17, there are, for example, polyester resin, polyacrylic acid copolymer, polyacrylamide, or derivatives as well as partial hydrolysates thereof. In addition, there are a vinyl polymer such as polyvinyl acetate, polyacrylonitrile, polyacrylate, and polymers thereof, and a natural product such as rosin and shellac, and derivatives thereof, and the like. Moreover, emulsions such as styrene-butadiene copolymer, polyacrylic acid, polyacrylate and derivatives thereof, polyvinyl acetate-acrylate copolymer, polyolefin-vinyl acetate copolymer may also be used. Further, carbonate resin, polyester resin, urethane resin, epoxy resin, polyvinyl chloride, polyvinylidene chloride, polypyrrole, and the like may also be used. The thickness of the base layer 17 is preferably 1 μm to 50 μm both inclusive.

The base layer 17 is formed by coating and drying a coating liquid formed by dissolving the above-described material in a solvent. As the solvent, there are lower alcohols such as methanol, ethanol, and n-propanol, ketones such as acetone methyl ethyl ketone, and methyl isobutyl ketone, aromatic compounds such as toluene, benzene, cyclohexane, and xylene, esters of lower fatty acid such as methyl acetate, ethyl acetate, and butyl acetate with lower alcohol, and ethers such as dioxane, ethylene glycol monoethyl ester, and ethylene glycol monomethyl ester, and mixtures thereof.

In the radiation detecting element 2 of the present embodiment, the scintillator layer 12 in which unevenness in film thickness and film quality is reduced and the entire surface is flat like the first embodiment is also formed using the deposition apparatus 10 illustrated in FIG. 2, by releasing CsI and TlI from the releasing holes 41A1 to 41An and 41B1 to 41Bm. In other words, the distribution of the MTF characteristics of the scintillator layer 12 is reduced, and the noise performance and input characteristic are improved, enhancing the resolution property of the scintillator.

### Application Example

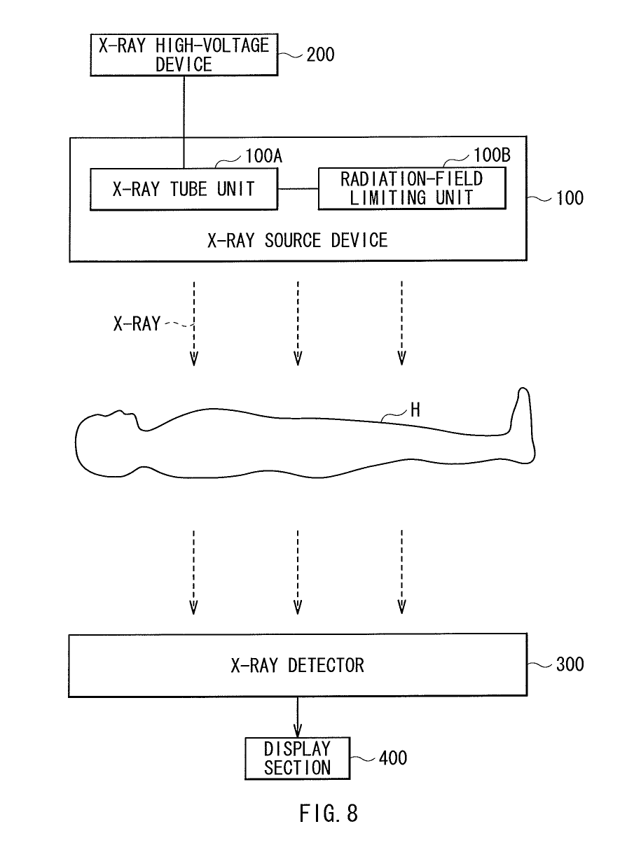

FIG. 8 illustrates a configuration of an X-ray diagnostic apparatus (roentgen) serving as an example of the radiation image diagnostic apparatus to which the radiation detecting element 1 or the radiation detecting element 2 in the embodiment described above is applied. This X-ray diagnostic apparatus is an image diagnostic apparatus that visualizes the transmission intensity of X-rays on a two-dimensional surface by using a radiation detecting module having the radiation detecting element 1 or the radiation detecting element 2 described above. The X-ray diagnostic apparatus includes, for example, an X-ray source device 100 including an X-ray tube unit 100A producing X-rays and a radiation-field limiting unit 100B limiting the range of the produced X-rays. The diagnostic apparatus further includes a cable (not illustrated) with a plug to guide a high voltage to the X-ray tube unit 100A, an X-ray high-voltage device 200 producing the high voltage, an X-ray detector 300 including a radiation (X-ray) detection module that detects the intensity of the X-rays passing through a specimen H, and a display section 400 displaying the detected X-rays on the two-dimensional surface.

In this X-ray diagnostic apparatus, the X-rays produced in the X-ray source device 100 are emitted to the specimen H, the X-rays after passing through the specimen H are detected by the X-ray detector 300, and an image visualized based on an intensity distribution of the detected X-rays is displayed in the display section 400.

The present technology has been described by using the first embodiment, the second embodiment, and the application example, but the present technology is not limited to the first and second embodiments and may be variously modified.

For example, in the embodiments described above, CsI (main agent) and TlI (activator) that are the deposition materials are separately contained in the vaporization containers 42A and 42B, respectively, but a mixture of the main agent and the activator may be contained in a single container and vaporized.

The present disclosure contains subject matter related to that disclosed in Japanese Priority Patent Application JP 2010-246506 filed in the Japan Patent Office on Nov. 2, 2010, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

1. A radiation detecting element comprising:
a scintillator layer on a substrate,
wherein the scintillator layer includes a plurality of columnar crystals having substantially no irregularity on each side.

2. The radiation detecting element according to claim 1, wherein a difference between a projection and a depression on an arbitrary part is 1 μm or less, in a growing direction of the plurality of columnar crystals.

3. The radiation detecting element according to claim 1, wherein a difference in column diameter between the plurality of columnar crystals is 30% or less.

4. The radiation detecting element according to claim 1, wherein a density distribution of the plurality of columnar crystals in the scintillator layer is uniform.

5. The radiation detecting element according to claim 1, wherein the plurality of columnar crystals each have a tip of which an angle of inclination is 40 degrees or less.

6. The radiation detecting element according to claim 1, wherein a difference in film thickness between a central part and a peripheral part in the scintillator layer is 10% or less.

7. The radiation detecting element according to claim 1, wherein the scintillator layer is formed by guiding a deposition material vaporized by application of heat to a deposition container having a plurality of releasing holes, and evaporating the deposition material from the plurality of releasing holes onto the substrate.

8. The radiation detecting element according to claim 1, wherein the scintillator layer includes cesium iodide (CsI).

9. A radiation detecting module comprising:
a radiation detecting element having a scintillator layer on a substrate; and
a photoelectric transducer transducing light, which is converted by the radiation detecting element, into an electric signal,
wherein the scintillator layer includes a plurality of columnar crystals having substantially no irregularity on each side.

10. A radiation image diagnostic apparatus comprising:
a radiation source device producing radiation; and
a radiation detector having a radiation detecting element and a photoelectric transducer transducing light, which is converted by the radiation detecting element, into an electric signal,
wherein the radiation detecting element has a scintillator layer on a substrate, and
the scintillator layer includes a plurality of columnar crystals having substantially no irregularity on each side.

11. A method of producing a radiation detecting element, the method comprising:
heating and vaporizing a deposition material;
guiding the vaporized deposition material to a deposition container having a plurality of releasing holes; and
forming a scintillator layer including a plurality of columnar crystals having substantially no irregularity on each side, by releasing the vaporized deposition material from the plurality of releasing holes, and evaporating the released deposition material onto the substrate.
